(19) United States
(12) Patent Application Publication
(10) Pub. No.: US 2006/0142937 A1
(43) Pub. Date: Jun. 29, 2006

(54) Web based land vehicle navigation system

(76) Inventors: Douglas L. Welk, Rossville, IN (US); Laci J. Jalics, Ray, MI (US); Mark K. Krage, Troy, MI (US); Francis E. Szczublewski, Macomb, MI (US)

Correspondence Address: DELPHI TECHNOLOGIES, INC., M/C 480-410-202, PO BOX 5052, TROY, MI, 48007, US

(21) Appl. No.: 11/311,736

(22) Filed: Dec. 19, 2005

Related U.S. Application Data
(60) Provisional application No. 60/640,118, filed on Dec. 29, 2004.

(51) Int. Cl. G01C 21/36

(52) U.S. Cl. 701/200; 701/201

(57) ABSTRACT

A web based navigation system for a land vehicle accesses a land navigation website and obtains land navigation data for traveling from a selected starting point to a selected destination. The land navigation data is transferred from the computer to the land vehicle wirelessly or by a portable data storage device and navigation instructions are presented to the driver of the land vehicle visually and/or audibly via a user interface device in the vehicle based on the land navigation data.

### RELATED PATENT APPLICATION

Applicants claim benefit of U.S. Provisional Patent Application No. 60/640,118 filed Dec. 29, 2004.

### FIELD OF THE INVENTION

This invention relates generally to navigation systems and more particularly to land vehicle navigation systems.

### BACKGROUND OF THE INVENTION

Navigation systems provide information in a number of ways, such as maps and routing instructions, which enable people to travel from one location to another in a land vehicle. The basic information required for a route planning system in a land vehicle is: 1) a selected starting location; 2) a selected destination location; 3) a database containing a road network that includes the selected starting and destination locations; 4) a route planning algorithm to select a route—that is, a series of interconnecting roads that connect the selected starting location to the selected destination location.

Stand-alone land vehicle navigation systems contain a road network data base, a route planning algorithm, a global positioning system (GPS) receiver and possibly dead reckoning sensors, a means for entering starting and destination locations and a means for displaying the route selected by the route planning algorithm visually and/or audibly. Typically, the visual display is a highlighted map and/or turn-by-turn instructions and audible output is voice instructions or tones played over the vehicle speakers. The cost of stand-alone land navigation systems is typically high due to the need for a large, up-to-date road database, a substantial computational capability to compute a route in a reasonable amount of time, GPS and possibly various sensors, and a high-resolution visual display. Another drawback of stand-alone land vehicle navigation systems is the accuracy of the road database, which can become outdated due to new road construction and changes in the existing road infrastructure.

Computers can access land vehicle navigation websites on the Internet. These websites provide route information in the form of maps and turn-by-turn instructions when the computer user provides the desired starting and destination locations. The route information is displayed on the computer screen, can be printed on paper, and/or stored in the computer for later use. This route information, in most cases, is available free except for any cost that is associated with accessing the Internet via a computer. The route information is very useful and typically a paper copy is made to navigate the route because the computer is not portable or if portable, is not convenient to use in the land vehicle. While the paper copy avoids the need for the computer, the paper copy itself is not in a very convenient format for the driver to use while driving. With the paper copy, the driver is forced to keep track of his or her location on the route and needs to anticipate the next maneuver on the route constantly. This problem increases with the complexity of the route, which may involve many roads and many turns. Additionally, driver safety issues may arise if the paper copy becomes misplaced or falls to the floor of the vehicle.

### SUMMARY OF THE INVENTION

This invention provides a low cost navigation system for a land vehicle that takes advantage of the route information available on the Internet while avoiding the necessity of a paper copy of the route information or a portable computer and the drawbacks associated with them. In addition, the route information is preferably formatted or reconfigured for presentation in a manner that is more appropriate for the land vehicle environment. Navigation functionality is provided at a relatively low cost to the end user/consumer because a high cost computer and large display is not required in the land vehicle.

### BRIEF DESCRIPTION OF THE DRAWINGS

FIG. 1 is a flow chart showing the progress of a web based land navigation system of the invention; and

FIG. 2 is a typical summary of driving instructions from a navigation website, such as MapQuest.com.

### DETAILED DESCRIPTION OF PREFERRED EMBODIMENT

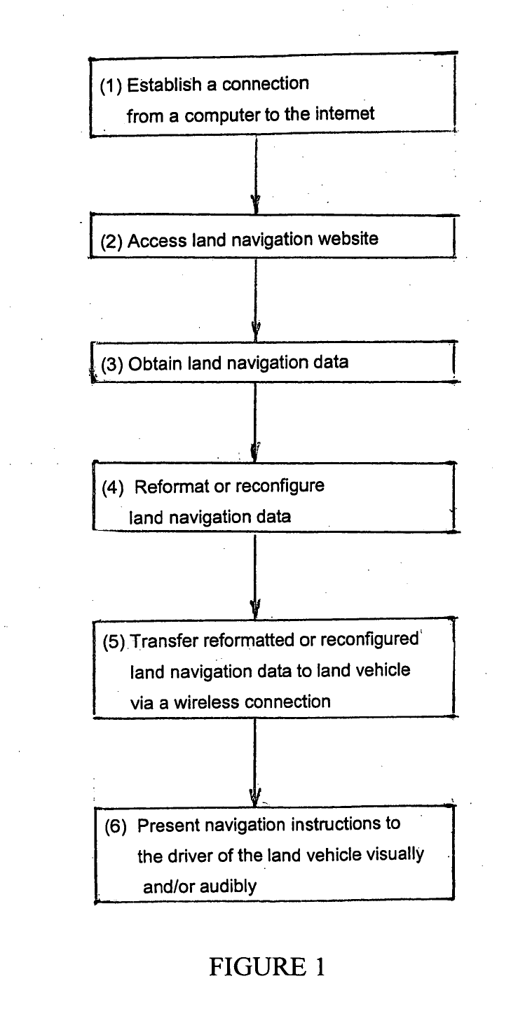

Referring now to the flow chart of FIG. 1, the web based navigation system of the invention comprises: (1) establishing a connection from a computer to the internet, (2) accessing a land navigation website, such as for example, MapQuest.com; (3) obtaining land navigation data for traveling from a selected starting point to a selected destination; (4) reformatting the land navigation data for a land vehicle environment; (5) transferring the reformatted land navigation data to a user interface device in the land vehicle via a wireless connection to the land vehicle; and (6) presenting navigation instructions to the driver of the land vehicle visually and/or audibly via the user interface device using the reformatted land navigation data.

In establishing the connection from a computer to the internet, a home computer is typically used. However, any suitable computer that can operate independently of the land vehicle except perhaps for a power source can be used. Once the Internet connection is established, the land navigation website is accessed and the land navigation data for traveling from a selected starting point to a selected destination are obtained in a conventional manner.

The land navigation data is then reformatted for a land vehicle environment, preferably by a computer program in the computer. The reformatted land navigation data is then transferred to a user interface device in the land vehicle via a wireless connection to the land vehicle by the computer for example by Wi-Fi or other suitable wireless networking system.

Navigation instructions are then presented to the driver of the land vehicle via the user interface device using the reformatted land navigation data. In this regard the user interface device must include capabilities to receive the reformatted data wirelessly, read the reformatted data and present the reformatted data visually and/or audibly.

As indicated above, the land navigation data is preferably reformatted by the computer. This is preferred for economic reasons to keep the user interface device as simple as possible. However, it is possible to include the reformatting capability in the user interface device and reformat the land navigation data in the user interface device and merely have the computer send the land navigation data to the user interface device.

The navigation instructions can be presented to the driver visually in various levels depending on the system sophistication. In addition to the visual presentations, turn information can also be presented audibly via recorded messages or text-to-speech in any of the various levels.

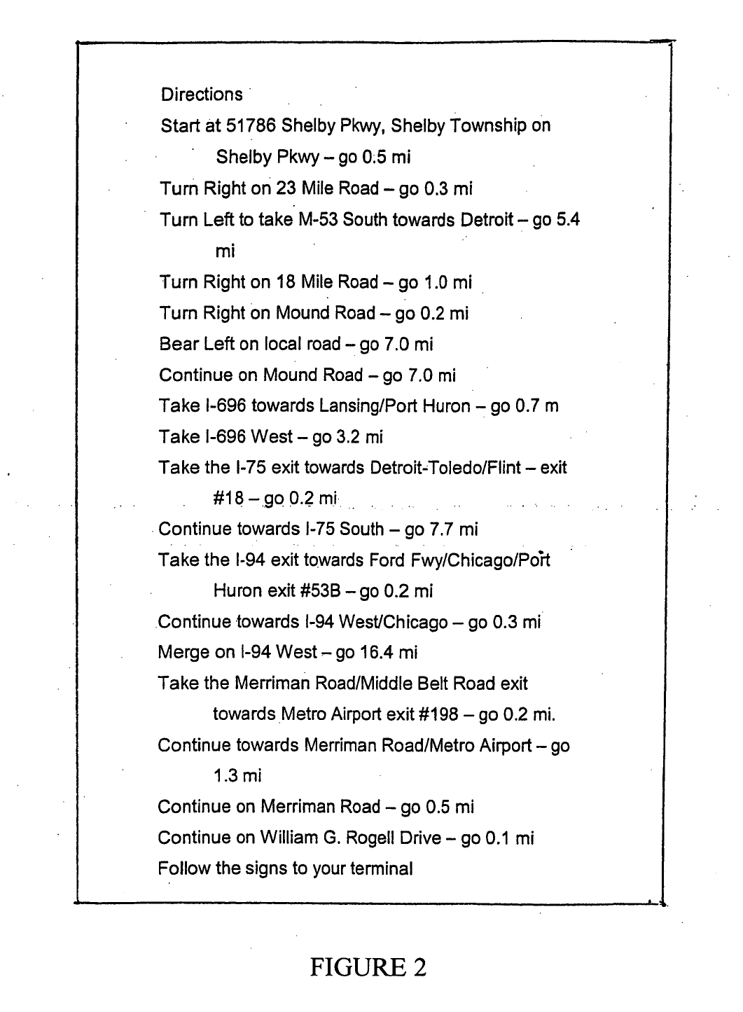

In a base level system, the navigation instructions would simply be in the form of turn-by-turn instructions from the website, such as shown in FIG. 2, displayed visually on a screen. However, the data could be manipulated to permit scrolling or indexing through the list of instructions to display the next appropriate turn or turns on the screen. The base level system provides limited advantages over the paper list because it allows for presentation of the instructions in a manner that is more appropriate for vehicle instructions.

In a mid-level system, the visual presentation of the turn-by-turn instructions from the website is automated by tying in the odometer of the land vehicle. When the route information is transferred to the land vehicle, the driving distance of each turn maneuver is also transferred as shown in FIG. 2. The on-board display then makes use of this information by coupling the driving distance with the vehicle's current location as reported by the odometer to present the next maneuver at an appropriate time, for example at a quarter (¼) mile in advance on most surface streets.

In a high level system the visual presentation of the turn-by-turn instructions from the website is automated by tying in the odometer of the land vehicle and adding a more precise positioning device such as GPS which can provide more accurate location information. When route information is transferred to the land vehicle, the GPS position of each turn is also transferred. Several turn instructions per maneuver can be given as the land vehicle approaches the required maneuver. The high-level system produces a very high confidence the vehicle has turned at the appropriate intersection.

This invention provides a low-cost navigation system where navigation data is taken from an Internet website, such as MapQuest.com, transferred to the vehicle, and then presented to the driver in a format appropriate to a land vehicle environment. While elements of the system are already known, the system taken as a whole is a new invention. The thrust of the invention is taking data formatted for a web browser, transferring the data to the vehicle via for example, IEEE 802.11 or a portable storage medium, and reformatting or reconfiguring the data for the vehicle environment either before or after the data is transferred. In reformatting or reconfiguring web data to fit the vehicle environment, driver distraction issues and limited human machine interfaces must be taken into account. This reformatting or reconfiguration is an important part of this invention. Getting this information reliably from the web site is also important.

As indicated above, several levels of implementation for the system can be considered. Base Level: A base-level implementation might simply present the turn list to the driver at his request. The operator would assume all responsibility for scrolling through the list and locating the appropriate next turn. Obviously, this implementation provides advantage over the paper or PDA system by allowing for vehicle-appropriate control and display.

Mid Level: The mid-level implementation expands on the mid level by automating the presentation of the turn information to the driver. When the route information is transferred to the vehicle, the odometer location of each turn maneuver is also transferred. The user interface device then makes use of this information, coupled with the vehicle's current location as reported by the odometer to present the next maneuver at an appropriate time (¼ mile in advance, for example). The turn information might also be given to the driver audibly either as an option or as an add-on.

High Level: The high-level implementation expands on the mid level by adding a more precise positioning device. A GPS based system can provide more accurate location information. Several turn instructions per maneuver can be given, and there is higher confidence that the vehicle turned at the appropriate intersection.

In other words, it will be readily understood by those persons skilled in the art that the present invention is susceptible of broad utility and application. Many embodiments and adaptations of the present invention other than those described above, as well as many variations, modifications and equivalent arrangements, will be apparent from or reasonably suggested by the present invention and the foregoing description, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the following claims and the equivalents thereof.

We claim:

1. A web based navigation system for a land vehicle comprising: (1) accessing a land navigation website by a computer and obtaining land navigation data for traveling from a selected starting point to a selected destination; (2) transferring the land navigation data from the computer to the land vehicle wirelessly or by a portable data storage device; and (3) presenting navigation instructions to the driver of the land vehicle visually and/or audibly via a user interface device in the vehicle based on the land navigation data.

2. The web based navigation system as defined in claim 1 wherein the land navigation data is reformatted or reconfigured by the computer before the land navigation data is transferred to the land vehicle.

3. The web based navigation system as defined in claim 1 wherein the land navigation data is reformatted or reconfigured by the user interface device before navigation instructions are presented to the driver of the land vehicle.

4. A web based navigation system for a land vehicle comprising: (1) establishing a connection from a computer to the internet; (2) accessing a land navigation website, such as for example, MapQuest.com; (3) obtaining land navigation data for traveling from a selected starting point to a selected destination; (4) reformatting and transferring the land navigation data to a user interface device in the land vehicle via a wireless connection or by a portable data storage device; and (5) presenting navigation instructions to the driver of the land vehicle visually and/or audibly via the user interface device.

5. The web based navigation system as defined in claim 4 wherein the navigation instructions are presented to the driver visually and/or audibly in a low level system.

6. The web based navigation system as defined in claim 4 wherein the navigation instructions are presented to the driver visually and/or audibly in a mid level system.

7. The web based navigation system as defined in claim 4 wherein the navigation instructions are presented to the driver visually and/or audibly in a high level system.

8. The web based navigation system as defined in claim 4 wherein the computer reformats and transfers the land navigation data to a user interface device in the land vehicle via the wireless connection or by a portable data storage device.

9. The web based navigation system as defined in claim 8 wherein the navigation instructions are presented to the driver visually and/or audibly in a low level system.

10. The web based navigation system as defined in claim 8 wherein the navigation instructions are presented to the driver visually and/or audibly in a mid level system.

11. The web based navigation system as defined in claim 8 wherein the navigation instructions are presented to the driver visually and/or audibly in a high level system.
